(19) United States
(12) Patent Application Publication
(10) Pub. No.: US 2007/0016341 A1
(43) Pub. Date: Jan. 18, 2007

(54) Traveling vehicle system and stop control method for traveling vehicle

(75) Inventor: Atsuo Nagasawa, Hashima-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/482,758

(22) Filed: Jul. 10, 2006

(30) Foreign Application Priority Data
Jul. 12, 2005 (JP) 2005-202451

(51) Int. Cl. G01C 21/00

(52) U.S. Cl. 701/1; 701/200

(57) ABSTRACT

A first mark 20 is provided before a target stop position, and a second mark 22 is provided between the first mark 20 and the target stop position. When a mark sensor 24 of a traveling vehicle 8 detects the first mark 20, a speed pattern generation unit 26 generates a speed pattern for the remaining distance. When the mark sensor 24 detects the second mark 22, the speed pattern 26 newly generates a speed pattern, and the traveling vehicle 8 stops at the target stop position.

### Technical Field

The present invention relates to a traveling vehicle system in which a traveling vehicle can stop at a target position without any creep traveling (traveling at a very low speed).

### BACKGROUND ART

According to the disclosure of Japanese Laid-Open Patent Publication No. 2004-287555, a plurality of dogs (marks that can be detected by a sensor) are provided before a target stop position for allowing a stacker crane to stop at the target stop position without any creep traveling. The inventor studied the technique for a traveling vehicle to stop further accurately without any creep traveling, and achieved the present invention.

### SUMMARY OF THE INVENTION

An object of the present invention is to control a traveling vehicle to stop at a target stop position accurately without any creep traveling.

Secondary object of the present invention is to control a traveling vehicle to stop at a target stop position smoothly.

Secondary object of the present invention is to allow a traveling vehicle to confirm whether the traveling vehicle stopped successfully within an allowable range from a target stop position or not.

In a traveling vehicle system according to the present invention, a traveling vehicle travels between stop positions along a travel route. The traveling vehicle system comprises at least two marks provided separately at known positions before a stop position in the travel route.

The traveling vehicle comprises detection means for detecting the marks; and means for generating a first speed pattern to stop at the stop position when a first mark is detected, and generating a second speed pattern to stop at the stop position when a second mark is detected.

The traveling vehicle travels from the first mark to the second mark in accordance with the first speed pattern, travels from the second mark to the stop position in accordance with the second speed pattern, and stops at the stop position.

It is preferable that the traveling vehicle further comprises a map of the travel route, and an encoder for counting the revolution number of a travel motor or the revolution number of a travel wheel; and

when the encoder detects that the traveling vehicle comes to a position close to the stop position by determining the position of the traveling vehicle on the map, deceleration of the traveling vehicle traveling toward the stop position is started before detection of the first mark.

In particular, it is preferable that the second mark comprises a mark formed by repeating a predetermined pattern at an equal pitch, and the detection means detects the pattern; and

the traveling vehicle further comprises confirmation means for counting the number of times the detected pattern is repeated, and confirming whether the traveling vehicle stopped within an allowable range from the stop position or not, based on the counted value when the traveling vehicle stopped.

Further, according to the present invention, a stop control method of controlling a traveling vehicle to travel and stop between stop positions along a travel route is provided. The method comprises the steps of:

providing at least two marks separately at known positions before a stop position in the travel route;

providing the traveling vehicle with detection means for detecting the marks;

providing the traveling vehicle with means for generating a first speed pattern to stop at the stop position when a first mark is detected, and generating a second speed pattern to stop at the stop position when a second mark is detected; and

controlling the traveling vehicle to travel from the first mark to the second mark in accordance with the first speed pattern, travel from the second mark to the stop position in accordance with the second speed pattern, and stop at the stop position.

In the present invention, when the traveling vehicle arrives at a position a predetermined distance before the stop position, it is possible to detect the first mark, and the first speed pattern from the position to the stop position is generated. For example, the initial value of the speed is a travel speed when the first mark is detected, and the speed pattern is constant deceleration for reducing the speed to “0” at the stop position. When the traveling vehicle detects the second mark before the stop position, the second speed pattern is newly generated in the same manner. Also at this time, the speed pattern is generated such that the traveling vehicle travels through a segment between known positions, and stops. When the traveling vehicle stops in accordance with the second speed pattern, the traveling vehicle should stop at a position near the stop position. Since the traveling vehicle travels through a short segment from a low speed until it stops in accordance with the second speed pattern, the error at the stop position is small. Further, since the speed of the traveling vehicle is reduced in accordance with the first pattern and the second pattern, the traveling vehicle passes a position around the second mark at a substantially predetermined speed. By the second speed pattern, the stop accuracy is further improved. As a result, the traveling vehicle can stop at the target stop position accurately without any creep traveling.

If it is detected that the traveling vehicle approaches the stop position before the first mark is detected using the map of the travel route and the encoder, it is possible to start deceleration before the first mark, i.e., on the upstream side of the first mark. Therefore, the traveling vehicle can pass the first mark at substantially a predetermined speed. Thus, the stop control is implemented further accurately.

In the case where the second mark comprises a mark formed by repeating a predetermined pattern at an equal pitch such as a comb-like mark, and the number of times the pattern is repeated is counted, the traveling vehicle can detect the deviation (error) between the actual stop position and the target stop position. If the error is large, the traveling vehicle should travel again to the target stop position. By memorizing the error data of the stop position, or creating statistical data from the error data and memorizing the statistical data, such data can be used in determining the necessity of maintenance operation for the traveling vehicle.

### BRIEF DESCRIPTION OF THE DRAWINGS

FIG. 1 is a plan view showing the layout of a traveling vehicle system according to an embodiment.

FIG. 2 is a block diagram showing positions of marks, and a travel control system of a traveling vehicle in the traveling vehicle system according to the embodiment.

FIG. 3 is a graph showing detection of marks, update of the remaining travel distance, and generation of speed patterns.

### BRIEF DESCRIPTION OF THE SYMBOLS

2. Traveling vehicle system

4. Inter-bay route

6. Intra-bay route

8. Traveling vehicle

10. Controller

12. Branch section

14. Merge section

16. Curve entrance

18. Curve exit

20, 22 Mark

24. Mark sensor

26. Speed pattern generation unit

28. Counter

30. Travel control unit

32. Travel motor

34. Encoder

36. Map

38. Linear sensor

### EMBODIMENT

Hereinafter, an embodiment in the most preferred form for carrying out the present invention will be described.

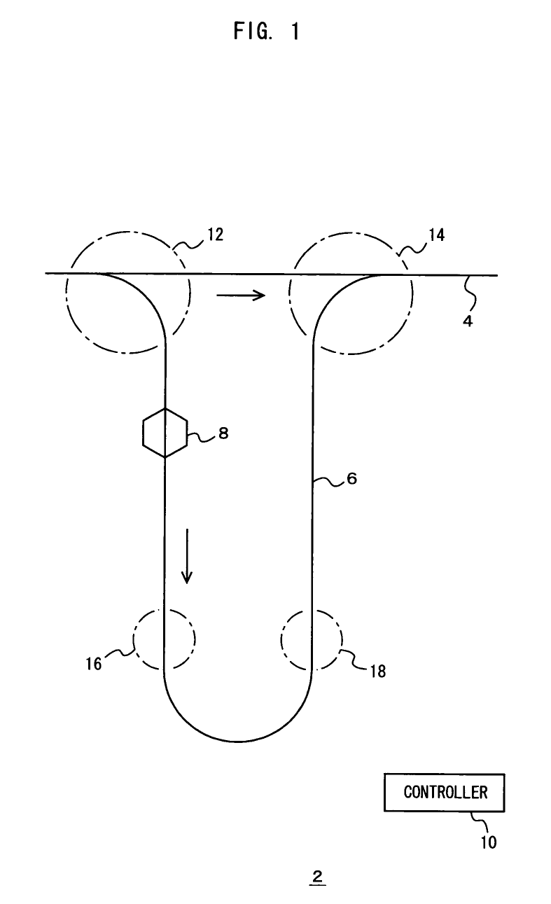

FIGS. 1 to 3 show a traveling vehicle system 2 according to the embodiment. In FIG. 1, a reference numeral 4 denotes an inter-bay route and a reference numeral 6 denotes an intra-bay route. The inter-bay route 4 is a long distance travel route as a main route. The intra-bay route 6 is provided for each bay in a semiconductor factory or the like. A reference numeral 8 denotes a traveling vehicle. The traveling vehicle 8 is an overhead traveling vehicle in the embodiment. Alternatively, the traveling vehicle 8 may be a rail vehicle on the ground, a stacker crane, or an automated non-rail guided vehicle on the ground. A reference numeral 10 denotes a controller for assigning a transportation command to the traveling vehicle 8 so that the traveling vehicle 8 can travel in accordance with the transportation command.

The routes 4, 6 include a branch section 12 and a merge section 14. The branch section 12 and the merge section 14 are referred to as the intersections, collectively. A reference numeral 16 denotes a curve entrance, and a reference numeral 18 denotes a curve exit. It is difficult to provide load ports (stations for transfer of articles) in the intersections, the curve entrance 16, and the curve exit 18. As described later, the traveling vehicle 8 is equipped with a linear sensor 38, and stops traveling when an elongated magnetic linear scale provided at a target stop position is read by the linear sensor 38. However, it is difficult to provide linear scales at the branch sections 12, the merge section 14, the curve entrance 16, and the curve exit 18. Therefore, it is difficult for the traveling vehicle 8 to stop in these segments accurately, and it is difficult to provide the load ports in these segments. In the embodiment, the load ports (not shown) are also provided in these segments as stop positions. The traveling vehicle 8 can stop at the stop position accurately without any creep traveling using two marks provided on the upstream side of the stop position.

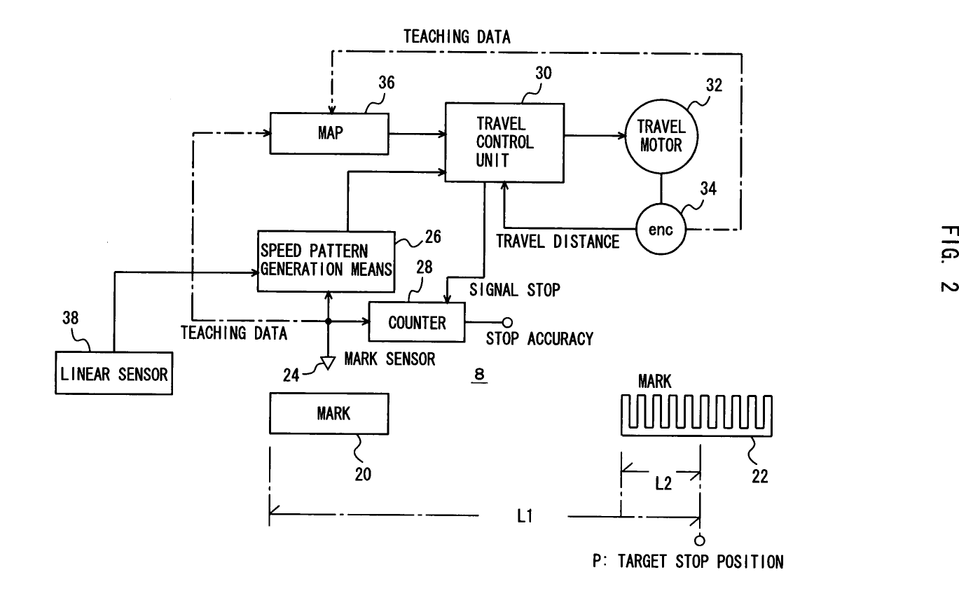

As shown in FIG. 2, a first mark 20 and a second mark 22 are provided on the upstream side (before) a target stop position P. The types of the marks 20, 22 can be selected arbitrarily. However, preferably, optical marks that can be detected easily are used as the marks 20, 22. Further, preferably, a comb-like mark is used as the second mark 22. The traveling vehicle 8 is equipped with a mark sensor 24 for detecting an edge of the first mark 20 on the upstream side, an edge of the second mark 22 on the upstream side, and respective comb teeth of the second mark 22. Each time the mark 20 or 22 is detected, a speed pattern generation unit 26 generates a speed pattern up to the target stop position P.

The travel distance from the mark 20 or 22 to the target stop position P in the generated speed pattern is known. The initial value of the speed in the speed pattern is a speed at the time of passing the mark determined by an encoder 34 or the like. For example, the speed pattern is generated such that the traveling vehicle 8 can stop at the target stop position by constant deceleration motion. Further, since the deceleration starts based on a map 36 before detection of the first mark 20, the speed at the time of passing the mark 20 has substantially a predetermined value. In the speed pattern, the speed is reduced from substantially the predetermined initial speed to zero over the two segments having known distances. Therefore, the speed pattern can be generated easily, and the speed control can be implemented easily.

A counter 28 counts the number of the detected teeth of the comb-like second mark 22. Assuming that the traveling vehicle 8 stopped accurately at the target stop position, the value of the counter 28 is within a predetermined range, and the error at the stop position can be detected by the counter 28. A travel control unit 30 controls a travel motor 32 such that the traveling vehicle 8 stops at the target stop position in accordance with three speed patterns, i.e., the speed pattern from a departure point (not shown) to the target stop position, the speed pattern from the mark 20 to the target stop position, and the speed pattern from the mark 22 to the target stop position. The encoder 34 detects the revolution number of the travel motor 32 or the revolution number of travel wheels (not shown) to determine the travel distance. Further, the map 36 stores travel routes. In particular, the map 36 stores addresses of stop positions as data corresponding to the travel distance. Further, the traveling vehicle 8 has a linear sensor 38. At target stop positions in straight segments, other than the positions in the branch section, the merge section, the curve entrance, or the curve exit where it is not possible to provide linear scales, the linear sensor 38 is used for determining the remaining distance to the target stop position so that the traveling vehicle 8 can stop at the target stop position.

At the time of providing the travel route, the marks 20, 22 are installed at predetermined positions on the upstream side of the target stop position. It is possible to generate the map 36 using the marks 20, 22. For example, one traveling vehicle is selected from a plurality of traveling vehicles, and the selected traveling vehicle travels along the travel route to detect the marks 20, 22. The value of the encoder 34 is added to the travel distance L1 from the mark 20 to the target stop position, or the travel distance L2 from the mark 22 to the target stop position, and the obtained data is written as an address of the target stop position in the map 36. The address of the target stop position can be determined using any of the marks 20, 22. At the target stop position in the straight segment other than the branch section, the merge section, the curve entrance, and the curve exit, the linear scale (not shown) is provided. Therefore, the output of the encoder 34 when the linear sensor 38 detects that the traveling vehicle passes the target stop position is written as the address of the target stop position in the map 36. In this manner, the map 36 can be generated easily.

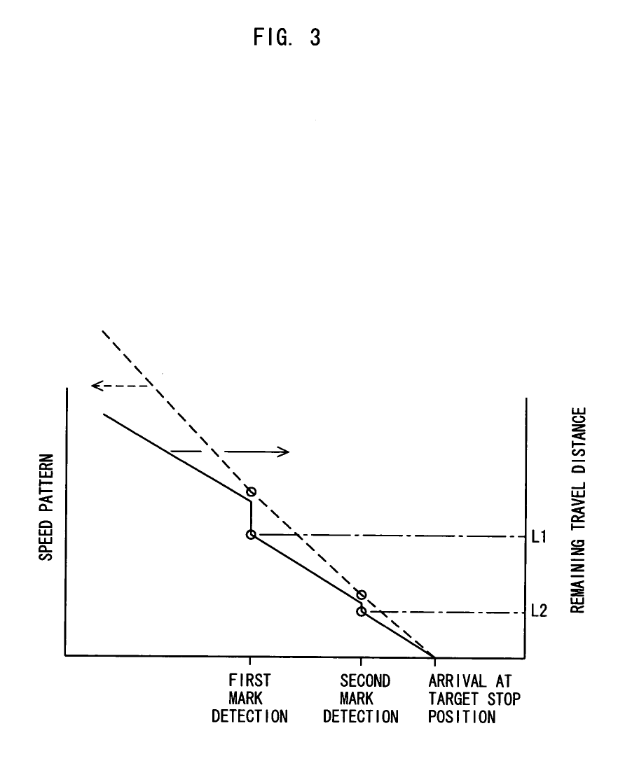

FIG. 3 shows the remaining travel distance to the target stop position as viewed from the traveling vehicle and speed patterns. Since the traveling vehicle has the map and the encoder, when the traveling vehicle comes to a position near the target stop position, the traveling vehicle starts deceleration before detection of the first mark, in accordance with the remaining travel distance to the target stop position. The speed of the traveling vehicle is controlled so that the traveling vehicle can pass the first mark at the predetermined speed. When the first mark is detected, the remaining travel distance is corrected to the known value L1, and the speed pattern generation unit generates a first speed pattern corresponding to the remaining travel distance L1 for allowing the traveling vehicle to stop by constant deceleration from the current speed. Then, the traveling vehicle travels in accordance with the first speed pattern that has been generated by detection of the first mark, until detection of the second mark. When the second mark is detected, since it is found that the remaining travel distance is L2, the speed pattern generation unit generates a second speed pattern for allowing the traveling vehicle to stop at the target stop position by constant deceleration from the speed at the time of detection of the second mark. Thus, after the second mark is detected, the traveling vehicle travels in accordance with the second speed pattern.

As a result, before the traveling vehicle stops at the target stop position, the two speed patterns are generated at the first mark and the second mark and the speed of the traveling vehicle is reduced from substantially the predetermined speed in accordance with the speed patterns. Thus, the traveling vehicle can stop at the target stop position without any creep traveling. In particular, when the second mark is detected, for example, the remaining travel distance L2 to the target stop position is small, about 20 to 100 mm, and the initial speed is small. Thus, the traveling vehicle 8 can stop at the target stop position with a small error.

Since the second mark is the comb-like mark, by counting the number of teeth of the comb-like mark, the error (deviation) between the actual stop position and the target stop position can be determined. For example, assuming that the pitch of the teeth of the comb-like mark is 2 mm, the stop position can be confirmed with an error of about ±1 mm. Therefore, when the traveling vehicle stops, if deviation from the target stop position is not within an allowable range, the traveling vehicles travels again after the stop, and moves to the target stop position. Further, the number of times the traveling vehicle stops at a position deviated from the target stop position may be counted. When the counted value reaches a predetermined value, information to this effect should be reported to the controller 10 so that the maintenance operation for the traveling vehicle can be performed.

In the embodiment, the following advantages can be obtained.

(1) Since two speed patterns are generated at known positions before the target stop position, the traveling vehicle can stop at the target stop position accurately without any creep traveling.

(2) By providing the map and the encoder, deceleration is started before detection of the first mark, and the traveling vehicle can pass the first mark at substantially the predetermined speed.

(3) It is possible to detect the error of the stop position from the target stop position.

(4) Thus, the traveling vehicle can stop accurately at a position where the linear scale cannot be provided, such as the branch section, the merge section, or the entrance/exit of the curve segment, and it is possible to provide the load ports at positions in these segments.

1. A traveling vehicle system wherein a traveling vehicle travels between stop positions along a travel route, the traveling vehicle system comprising
at least two marks provided separately at known positions before a stop position in the travel route,
the traveling vehicle comprising:
detection means for detecting the marks; and
means for generating a first speed pattern to stop at the stop position when a first mark is detected, and generating a second speed pattern to stop at the stop position when a second mark is detected, wherein
the traveling vehicle travels from the first mark to the second mark in accordance with the first speed pattern, travels from the second mark to the stop position in accordance with the second speed pattern, and stops at the stop position.

2. The traveling vehicle system of claim 1, wherein the traveling vehicle further comprises a map of the travel route, and an encoder for counting at least one of a revolution number of a travel motor and a revolution number of travel wheels, and wherein
when the encoder detects that the traveling vehicle comes to a position close to the stop position by determining the position of the traveling vehicle on the map, deceleration of the traveling vehicle traveling toward the stop position is started before detection of the first mark.

3. The traveling vehicle system of claim 2, wherein the second mark comprises a mark formed by repeating a predetermined pattern at an equal pitch, and the detection means detects the pattern; and
the traveling vehicle further comprises confirmation means for counting the number of times the detected pattern is repeated, and confirming whether the traveling vehicle stopped within an allowable range from the stop position or not, based on the counted value when the traveling vehicle stopped.

4. A stop control method of controlling a traveling vehicle to travel and stop between stop positions along a travel route, the method comprising the steps of:
providing at least two marks separately at known positions before a stop position in the travel route;
providing the traveling vehicle with detection means for detecting the marks;
providing the traveling vehicle with means for generating a first speed pattern to stop at the stop position when a first mark is detected, and generating a second speed pattern to stop at the stop position when a second mark is detected; and
controlling the traveling vehicle to travel from the first mark to the second mark in accordance with the first speed pattern, travel from the second mark to the stop position in accordance with the second speed pattern, and stop at the stop position.
